(19) United States
(12) Patent Application Publication
(10) Pub. No.: US 2009/0119400 A1
(43) Pub. Date: May 7, 2009

(54) Presence Management System

(75) Inventor: Shigeru Fukazawa, Hachioji-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/182,789

(22) Filed: Jul. 30, 2008

(30) Foreign Application Priority Data
Nov. 1, 2007 (JP) 2007-285141

(51) Int. Cl. G06F 15/173

(52) U.S. Cl. 709/224

(57) ABSTRACT

According to one embodiment a presence management system including: a first presence server that controls a first network; a plurality of presentities that belong to the first network; a second presence server that controls a second network, the second network connected to the first network via a communication channel; and a plurality of watchers belonging to the second network; wherein the first presence server includes: a first watcher list that registers a given presentity under the first network associated with one of the watchers that requests presence information of the given presentity; and an external notification section that sends the presence information of the given presentity to the second presence server, and wherein the second presence server includes: a second watcher list that registers the one of watchers associated with the given presentity; and an internal notification section that sends the presence information to the one of watchers registered correspondingly to the given presentity.

### CROSS-REFERENCE TO RELATED APPLICATIONS

This application is based upon and claims the benefit of priority from JP-A-2007-285141, filed Nov. 1, 2007, the entire contents of which are incorporated herein by reference.

### BACKGROUND

1. Field

One embodiment of the invention relates to a presence management system that can manage the presence of the user through a network.

2. Description of the Related Art

A system having a function of managing the state of each user participating in a network is known, for example, as disclosed in patent documents: JP-A-2005-190287; JP-A-2006-244100; and JP-A-2005-275755. In the system having the function, the state for each user (online, offline, during telephone conversation, leaving a seat, seating, etc., which will be hereinafter collectively called presence) is stored in a database for management. If the presence of each user changes, an event notification message indicating that the presence of the user changes is sent from a terminal to a server and the database is updated. SIP (Session Initiation Protocol) is a representative protocol for message transfer.

For example, another user may want to know the most recent state of one user. Then, a system for meeting such a request by registering “which of the users wants to know the state of which of the users” in the system is provided, one example of which is instant messenger (IM). The user (or the terminal) of the “party of making the presence open” is called presentity and the user (or the terminal) of the “party of viewing the presence” is called watcher.

In this kind of system, a server for managing the presence (which will be hereinafter called presence server) is provided in a LAN (Local Area Network) constructed for each location (for example, office, etc.,). If the presence server receives a presence change notification from a presentity under the command of the presence server, immediately it sends a notification indicating the presence change to a watcher under the command of the presence server.

By the way, this kind of system starts to be applied even in a comparatively wide area network where a plurality of locations are connected by a dedicated line, etc. In such a system, the presentity and the watcher can belong to different LANs. In such an environment, it is pointed out that whenever the presence of the presentity changes, traffic across the locations occurs and the traffic involved in presence notification puts a squeeze on the line capacity connecting the LANs. Such traffic grows with an increase in the number of the watchers and by extension has a harmful effect on communications requiring a real time property such as voice communications; some measures need to be taken against the problem.

As described above, in the related arts, whenever the state of a presentity changes, a notification that the state of the presentity changes is sent to a watcher. Thus, if the presentity and the watcher belong to different presence servers, a squeeze is easily put on the line capacity connecting the servers and some measures need to be taken against the problem.

It is therefore an object of the invention to provide a presence management system intended for reducing the traffic amount involved in presence change notification, thereby lightening the network load.

### BRIEF DESCRIPTION OF THE SEVERAL VIEWS OF THE DRAWINGS

FIG. 1 is an exemplary drawing to show an embodiment of a presence management system according to the invention.

FIG. 2 is an exemplary drawing to illustrate the relationship between a presentity and watchers.

FIG. 3 is an exemplary drawing to schematically show the relationship between presentities and watchers.

FIG. 4 is an exemplary functional block diagram to show one embodiment of a present server A, B.

FIG. 5 is an exemplary drawing to show one example of a first presence management table 35a.

FIG. 6 is an exemplary drawing to show one example of a first watcher list 35b of the presence server A.

FIG. 7 is an exemplary drawing to show one example of a second watcher list 35c of the presence server B.

FIG. 8 is an exemplary drawing to show one example of a second presence management table 35d.

FIG. 9 is an exemplary flowchart to show a processing procedure in the presence server receiving a notification programming message of presence information from a watcher.

FIG. 10 is an exemplary chart to show a signal sequence in the case of NONE in the search at step S2 in FIG. 9.

FIG. 11 is an exemplary chart to show a signal sequence in the case of FOUND in the search at step S2 in FIG. 9.

FIG. 12 is an exemplary chart to show a signal sequence when the state of a presentity to whom notification programming of the presence state applies changes.

### DETAILED DESCRIPTION

Various embodiments according to the invention will be described hereinafter with reference to the accompanying drawings. In general, according to one embodiment of the invention, a presence management system includes: a first presence server that controls a first network; a plurality of presentities that belong to the first network; a second presence server that controls a second network, the second network connected to the first network via a communication channel; and a plurality of watchers belonging to the second network; wherein the first presence server includes: a first watcher list that registers a given presentity under the first network associated with one of the watchers that requests presence information of the given presentity; and an external notification section that sends the presence information of the given presentity in the first watcher list as a presence message to the second presence server through the communication channel, and wherein the second presence server includes: a second watcher list that registers the one of watchers associated with the given presentity; and an internal notification section that sends the presence information as the presence message to the one of watchers registered in the second watcher list correspondingly to the given presentity.

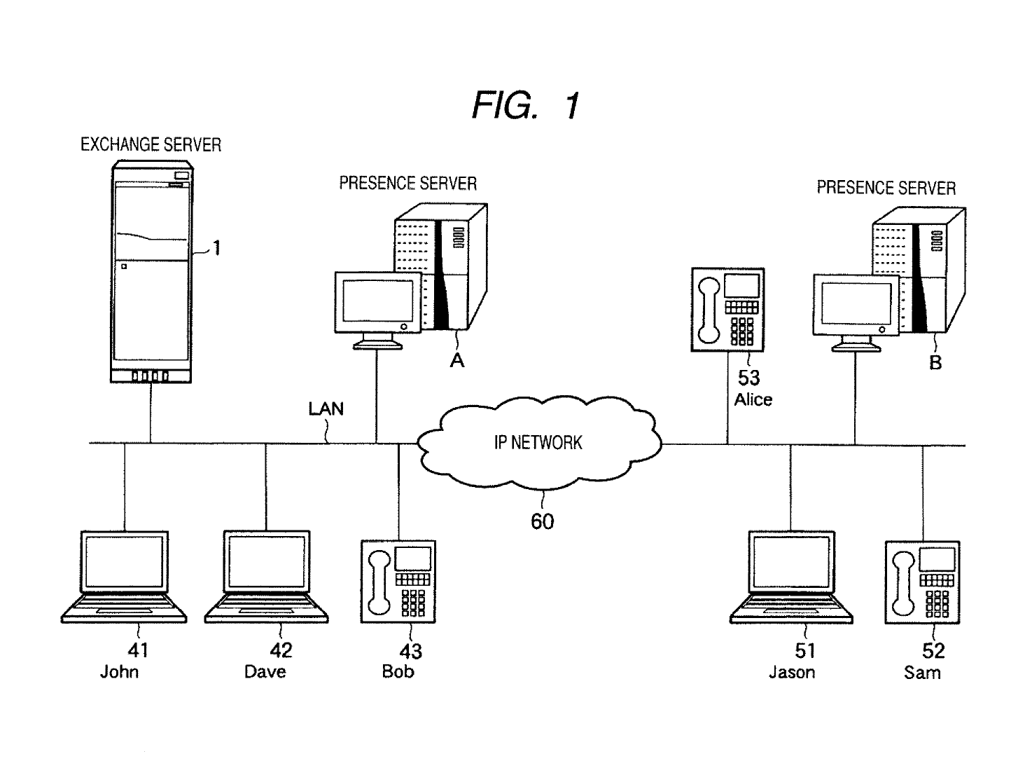

FIG. 1 is a drawing to show an embodiment of a presence management system according to the invention. In the embodiment, a VoIP (Voice over IP) system for transferring an IP packet through an IP network 60, thereby realizing voice communications is taken as an example.

In FIG. 1, local networks formed in different locations are connected through the IP network 60. Each local network is formed by connecting terminals through a LAN. An exchange server 1, a presence server A, PC (personal computer) terminals 41 and 42, and an IP telephone 43 are connected to one of the LANs. The presence server A collectively manages the presence of the users of the PC terminals 41 and 42 and the IP telephone 43 under the command of the presence server A.

A presence server B, a PC terminal 51, and IP telephones 52 and 53 are connected to the other LAN. The presence server B collectively manages the presence of the users of the PC terminal 51 and the IP telephones 52 and 53 under the command of the presence server B. The exchange server 1 controls extension communications in each LAN and outside line communications via the IP network 60.

In the description to follows the users of the terminals are distinguished from each other. As shown in the figure, the users of the PC terminals 41 and 42 and the IP telephone are named John, Dave, and Bob respectively. The users of the PC terminal 51 and the IP telephones 52 and 53 are named Jason, Sam, and Alice respectively.

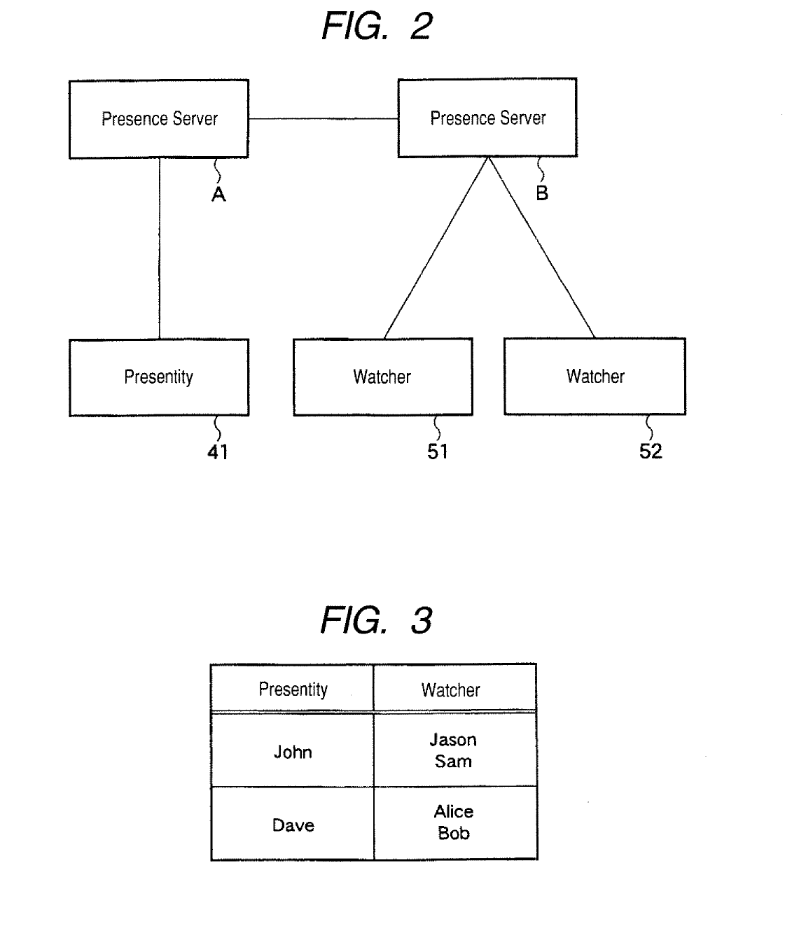

FIG. 2 is a drawing to illustrate the relationship between a presentity and watchers. The presentity and watchers belong to the presence servers. In FIG. 2, the PC terminal 41 is the presentity and is under the command of the presence server A. The PC terminal 51 and the IP telephone 52 are the watchers of the presentity and are under the command of the presence server B.

The presentity 41 sends a notification of the presence status of the user to the presence server A just above the presentity 41. Each of the watchers 51 and 52 programs the presence server A to send a notification of presence information of the presentity 41 via the presence server B. Accordingly, whenever the state of the presentity 41 changes or at regular time intervals, a notification is sent to the watchers 51 and 52. Information indicating “which watcher programs the presence server to send a notification of presence information of which presentity” is stored in a database for management in the system, for example, as shown in FIG. 3. For example, the watchers “Jason” and “Sam” program the presence server to send a notification of presence information of the presentity “John.” Likewise, the watchers “Alice” and “ob” program the presence server to send a notification of presence information of the presentity “Dave.” In the embodiment, the database will be discussed in detail.

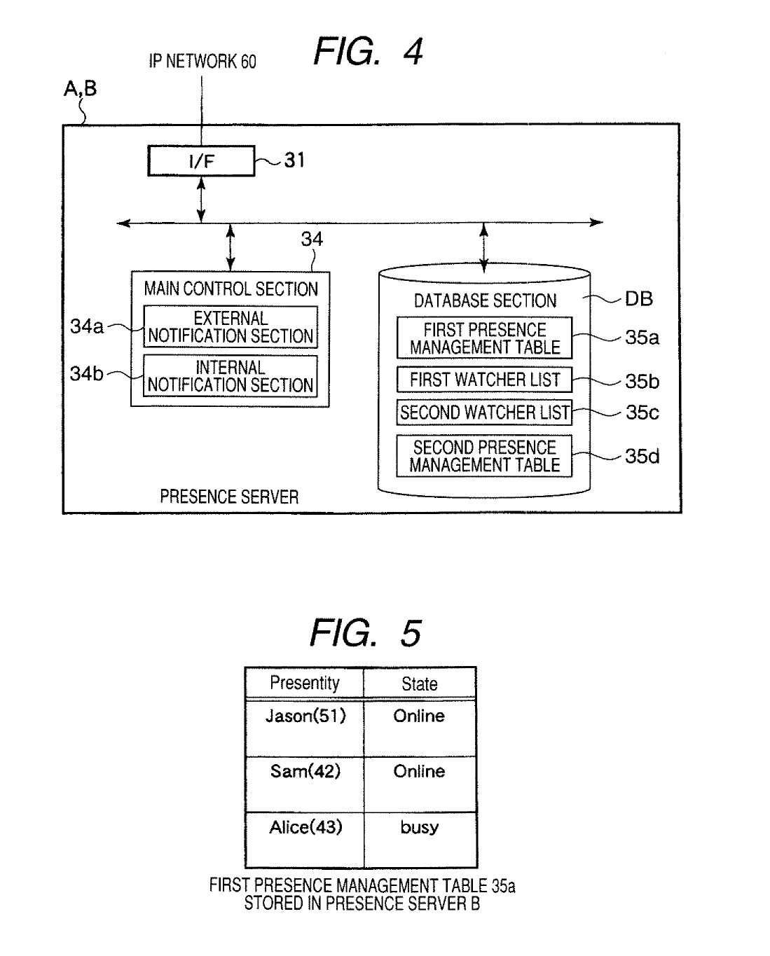

FIG. 4 is a functional block diagram to show one embodiment of the present server A, B in FIG. 1. The present server A, B includes an interface section (I/F) 31, a database section DB, and a main control section 34. The I/F 31 is connected to the IP network 60 for performing processing concerning transfer of a packet.

The database section DB stores a first presence management table 35a, a first watcher list 35b, a second watcher list 35c, and a second presence management table 35d. The first presence management table 35a is a table for managing the presence of each presentity in the LAN under the command of the presence server, as shown in FIG. 5. When the presence of the presentity changes, the presentity sends a notification that the presence of the presentity changes to the presence server just above the presentity as a PUBLISH messages etc. Upon reception of the notification, the presence server interprets the message and updates the first presence management table 35a for management. As is obvious, FIG. 5 shows the first presence management table stored in the presence server B.

If a request for acquiring the presence of a presentity under the command of the presence server is received from a watcher belonging to a different LAN, the first watcher list 35b is a list registering the requesting watcher in association with the presentity under the command of the presence server.

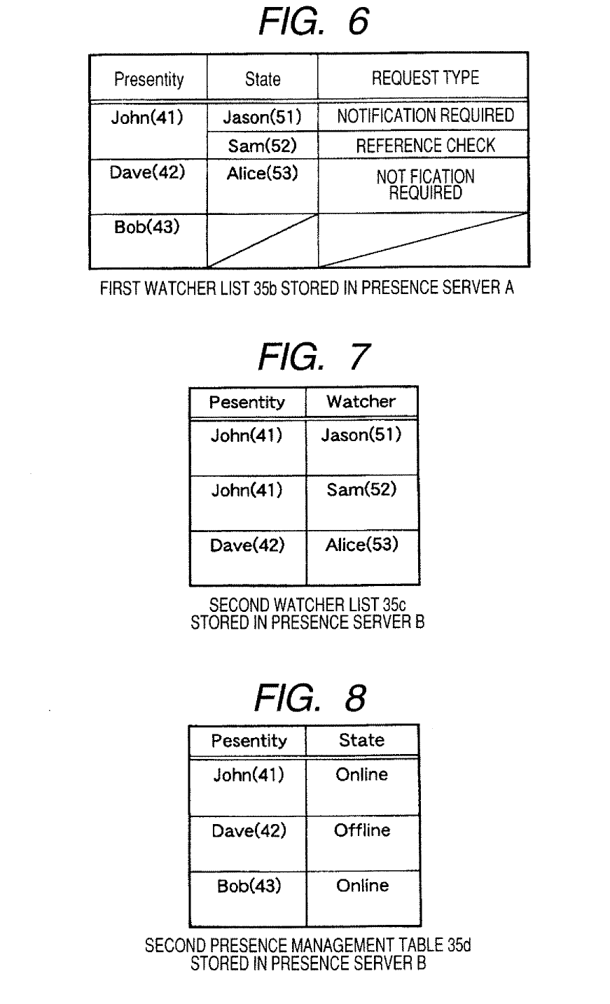

FIG. 6 is a drawing to show one example of the first watcher list 35b of the presence server A. A requesting watcher is registered in the list in association with the presentity (John, Dave, Bob) under the command of the presence server A, whose presence acquisition is requested by a watcher (Jason, Sam, Alice) in the LAN under the command of the presence server B. For example, John is under the command of the presence server A and the presence server A is programmed to acquire the presence of John by Jason under the command of the presence server B. Further, the attribute of the request type to distinguish the presence notification mode is associated with each watcher. In FIG. 6, “notification required” attribute is associated with Jason and Alice and “reference check” attribute is associated with Sam.

The second watcher list 35c is a list registering a watcher under the command of the presence server for making a request for acquiring the presence of a presentity in a different LAN in association with the presentity whose presence acquisition is requested.

FIG. 7 is a drawing to show one example of the second watcher list 35c of the presence server B. A watcher (Jason, Sam, Alice) under the command of the presence server B for making a request for acquiring the presence of a presentity (John, Dave, Bob) in the LAN under the command of the presence server A is registered in the list in association with the presentity in the LAN under the command of the presence server A. John is watched from both Jason and Sam so as to correspond to FIG. 5.

The second presence management table 35d is a table for temporarily managing the presence of each presentity managed by a different present server, as shown in FIG. 8. This means that the presence of the presentity under the command of the different present server reported from the different present server is stored in the second presence management table 35d rather than discarded after completion of the notification. FIG. 8 shows the second presence management table stored in the presence server B. For the presence server B, John, Dave, and Bob belong to the associated server (presence server A), but it is seen that a notification of the presence of every user (John, Dave, and Bob) has been sent to the presence server B. It is seen that only Dave is in an offline state. In FIGS. 5 to 8, the numerals enclosed in parentheses correspond to the numerals of the terminals in FIG. 1.

By the way, the main control section 34 includes an external notification section 34a and an internal notification section 34b as processing functions according to the embodiment. The external notification section 34a reads the presence of each presentity registered in the first watcher list from the first presence management table 35a and sends a presence message through the IP network 60 to a different presence server as a notification.

The internal notification section 34b sends a notification of the presence of the presentity reported as the presence message to the watcher registered in the second watcher list 35c in association with the presentity through the LAN under the command of the presence server. At the time, the presentity reported as the presence message is registered in the second presence management table 35d.

In addition, the main control section 34 also includes conventional processing functions of registering the presence reported from each presentity in the first presence management table 35a, accepting notification programming from a watcher under the command of the presence server, and the like.

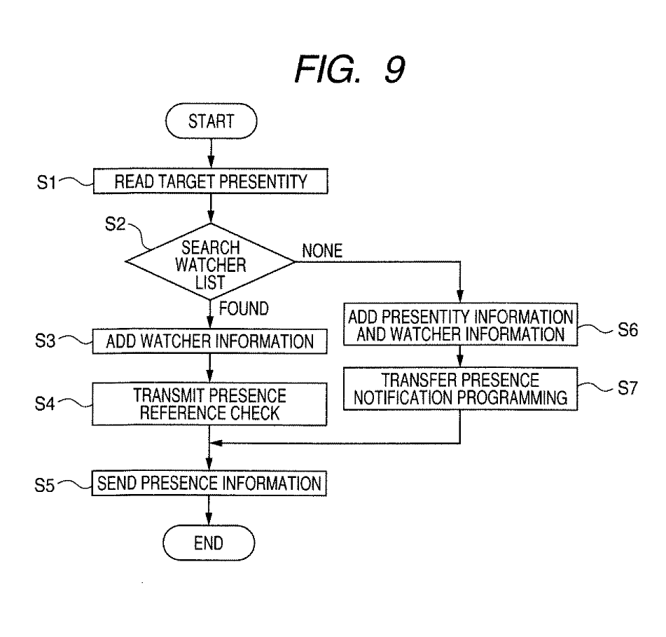

FIG. 9 is a flowchart to show a processing procedure in the presence server receiving a notification programming message of presence information from a watcher. In the description given here, the presence server B is the nucleus. In FIG. 9, upon reception of a notification programming message, the presence server B reads the identity (SIP, URI, etc.,) of the specified presentity from the message (step S1). Next, the presence server B searches the second presence management table 35d in FIG. 8 for the read presentity in the database (step S2).

For example, if the user Jason programs the presence server to send a presence notification of John, John is found in the search because John is listed in FIG. 8. Then, the presence server B newly adds programming Jason to the second watcher list 35c in FIG. 7 as a watcher of John (step S3). Subsequently, the presence server B transmits presence notification programming with reference check set as the request type to the presence server A (step S4) because the presence of John is retained in the second presence management table 35d in FIG. 8. Next, the presence server B reads the presence information of the specified presentity (John) from the second presence management table 35d and sends the presence information to the requester Jason (step S5).

In contrast, if the user Jason programs the presence server to send a presence notification of Jimmy (not shown), Jimmy is not found in the search. Then, the presence server B adds programming Jason (watcher) and specified Jimmy (presentity) to the second watcher list 35c in association with each other and updates the list (step S6). Subsequently, the presence server B transfers presence information notification programming to the presence server A (step S7). Upon reception of it, the presence server A updates the first watcher list 35b of the presence server A. If the presence of Jimmy exists in the first presence management table 35a, the presence of Jimmy is reported to Jason at step S7. The description has been given by taking the users Jason and Jimmy as an example; Jason is placed under the command of the presence server B and Jimmy is placed under the command of the presence server A.

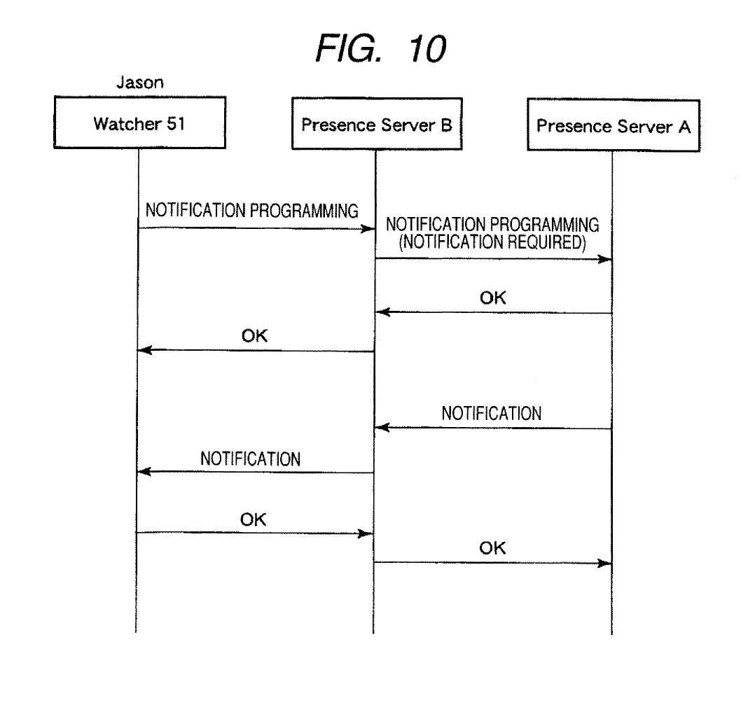

FIG. 10 is a chart to show a signal sequence in the case of NONE in the search at step S2 in FIG. 9. When a notification programming message of the presence of Jimmy arrives at the presence server B from Jason, the presence server B transfers the programming to the presence server A. The message request type is (notification required). In response to the message, an OK message is returned from the presence server A to Jason and later, when the presence of Jimmy changes, a notification of the presence change is sent from the presence server A via the presence server B to Jason.

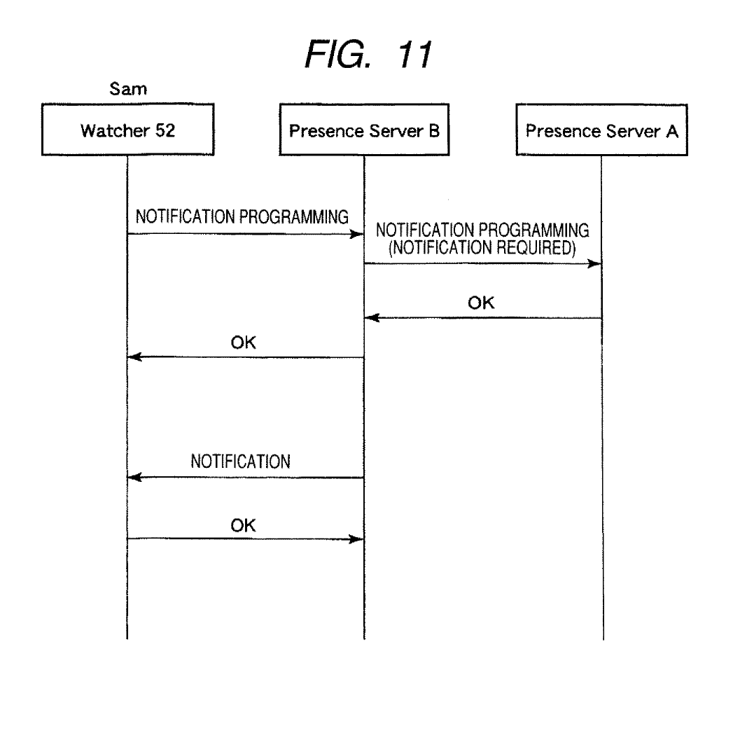

FIG. 11 is a chart to show a signal sequence in the case of FOUND in the search at step S2 in FIG. 9. When a notification programming message of the presence of John arrives at the presence server B from Sam, the presence server B retains the presence of John in the second presence management table 35d. Then, the presence server B transmits notification programming of presence information reference check to the presence server A. When permission (OK) arrives at the presence server B from the presence server A in response to the notification programming, the presence information of John read from the second presence management table 35d of the presence server B is transmitted to Sam.

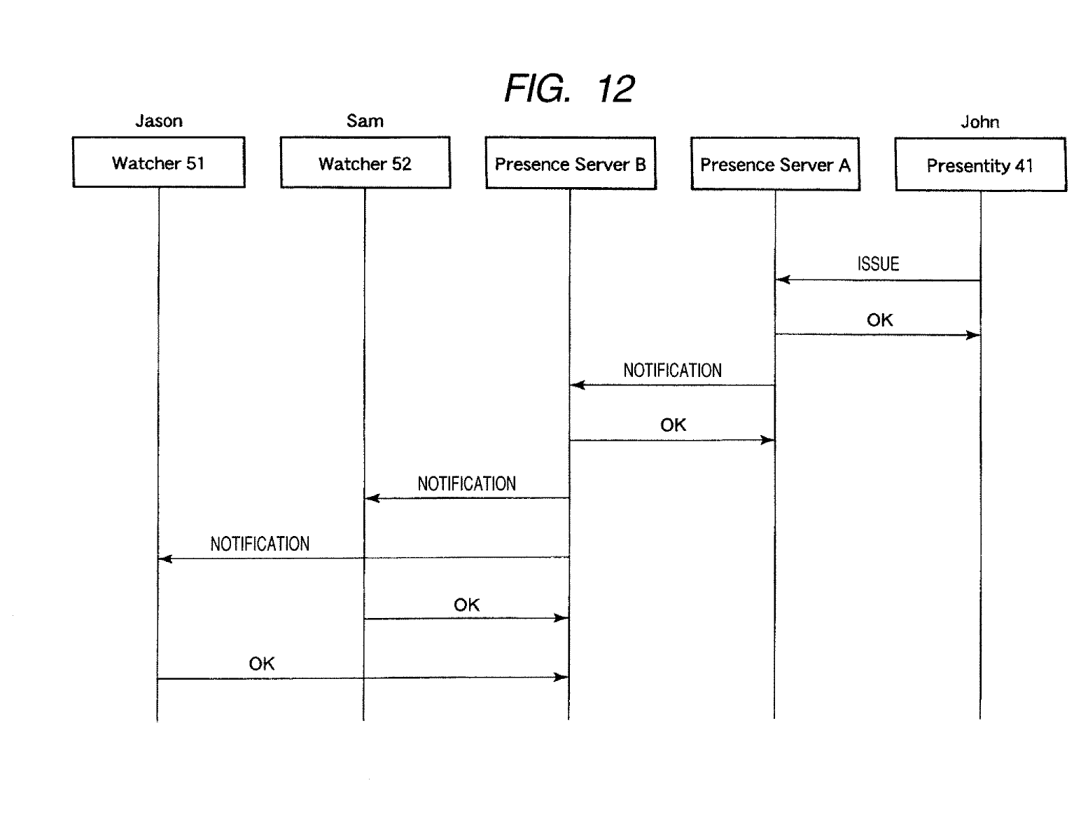

FIG. 12 is a chart to show a signal sequence when the state of the presentity to whom notification programming of the presence state applies changes. Although Jason and Sam send programming notification to the presence server B, the fact that only Jason requires notification is pointed out explicitly in the presence server A. Therefore, a notification of presence information is sent only once to the presence server B from the presence server A.

The presence server B searches the second watcher list 35c in FIG. 7 based on the presentity information sent from the presence server A, reads a watcher group under the command of the presence server B programming the presence server to send a notification, and distributes the presentity information sent from the presence server A to the watchers. That is, the presence of John is reported only once to the presence server B from the presence server A. Upon reception of it, the presence server B references the second watcher list 35c and finds out Jason and Sam of the watchers of John. Thus, the presence of John is reported to Jason and Sam by conducting communications in the LAN.

As described above, in the embodiment, both the first watcher list 35b and the second watcher list 35c are stored in the presence servers A and B with the LANs under the command of the presence server A and B. Each watcher belonging to the different LAN is recorded in the first watcher list 35b for each presentity under the command of the presence server in association with each other. Each watcher under the command of the presence server is recorded in the second watcher list 35c for each watcher belonging to the different LAN in association with each other. When a presence change event of any presentity occurs, the presence server just above the presentity references the first watcher list 35b and sends a notification message of the event occurrence to the different presence server through the IP network 60. Upon reception of the message, the presence server references the second presence management table 35d and sends a notification of the event to the watcher group making a presentity acquiring request of the presentity.

Thus, if a watcher and a presentity belong to different LANs, the need for sending as many messages as the number of watchers to the IP network 60 is eliminated. Therefore, according to the embodiment, when the presence state of the presentity belonging to a different server changes, the traffic involved in presence state notification can be minimized as necessary. Further, it is also made possible to realize the traffic when the presence server is programmed to send a notification of the presence state of a presentity belonging to a different server as the necessity minimum presence state notification. Thus, the traffic amount involved in presence change notification can be reduced and accordingly, it is made possible to provide a presence management system intended for lightening the network load.

It is to be understood that the invention is not limited to the specific embodiment described above. For example, the IP network 60 may be a dedicated line. The invention can be embodied with the components modified without departing from the spirit and scope of the invention. Further, the invention can be embodied in various forms according to appropriate combinations of the components disclosed in the embodiment described above. For example, some components may be deleted from all components shown in the embodiment.

As described with reference to the embodiment, there is provided a presence management system intended for reducing the traffic amount involved in presence change notification, thereby lightening the network load.

What is claimed is:

1. A presence management system comprising:
a first presence server that controls a first network;
a plurality of presentities that belong to the first network;
a second presence server that controls a second network, the second network connected to the first network via a communication channel; and
a plurality of watchers belonging to the second network;
wherein the first presence server includes:
a first watcher list that registers a given presentity under the first network associated with one of the watchers that requests presence information of the given presentity; and
an external notification section that sends the presence information of the given presentity in the first watcher list as a presence message to the second presence server through the communication channel, and
wherein the second presence server includes:
a second watcher list that registers the one of watchers associated with the given presentity; and
an internal notification section that sends the presence information as the presence message to the one of watchers registered in the second watcher list correspondingly to the given presentity.

2. The presence management system according to claim 1,
wherein the second presence server updates the one of watchers and the associated given presentity in the second watcher list when receiving a request for presence information with respect to the given presentity is transmitted from the one of watchers, and notifies the first presence server about updated information of the second watcher list including the one of watchers and the associated given presentity as a notification message through the communication channel; and
the first presence server updates the one of watchers and the associated given presentity in the first watcher list in accordance with the notification massage.

3. The presence management system according to claim 1,
wherein the second presence server includes a database storing presence information with respect to the plurality of presentities notified from the first presence server;
when the second presence server receives a request for acquiring the presence information of the given presentity, the second presence server confirms whether the given presentity is registered in the second watcher list; and
when the given presentity is registered in the second watcher list, the second presence server notifies the one of watchers through the second network about the requested presence information by reading out the requested presence information from the database.
